(19) United States
(12) Patent Application Publication
(10) Pub. No.: US 2015/0336088 A1
(43) Pub. Date: Nov. 26, 2015

(54) CATALYST AND METHOD FOR PREPARATION THEREOF

(71) Applicant: SHELL OIL COMPANY, Houston, TX (US)

(72) Inventors: Vikrant Nanasaheb URADE, Bangalore (IN); Alan Anthony DEL PAGGIO, Spring, TX (US); Laxmi Narasimhan CHILKOOR SOUNDARARAJAN, Bangalore (IN); Madhusudhan Rao PANCHAGNULA, Bangalore (IN)

(21) Appl. No.: 14/758,687

(22) PCT Filed: Dec. 19, 2013
(86) PCT No.: PCT/EP2013/077549

§ 371 Date: Jun. 30, 2015

(30) Foreign Application Priority Data
Dec. 31, 2012 (IN) 5513/CHE/2012

(51) Int. Cl. B01J 29/24; B01J 37/08; B01J 37/20; B01J 29/06; B01J 29/76; B01J 29/78

(52) U.S. Cl. CPC B01J 29/24; B01J 29/7615; B01J 29/7815; B01J 37/20; B01J 29/061; B01J 37/08; B01J 2229/183

(57) ABSTRACT

A process for converting one or more C3-C12 oxygenates comprising: contacting a feed, which feed comprises one or more C3-C12 oxygenates, with hydrogen at a hydrogen partial pressure of more than 1.0 MegaPascal in the presence of a sulphided carbon-carbon coupling catalyst; wherein the carbon-carbon coupling catalyst comprises equal to or more than 60 wt % of a zeolite and in the range from equal to or more than 0.1% wt to equal to or less than 10 wt % of a hydrogenation metal, based on the total weight of the carbon-carbon coupling catalyst; and wherein the zeolite comprises 10-membered and/or 12-membered ring channels and a Silica to Alumina molar Ratio (SAR) in the range from equal to or more than 10 to equal to or less than 300.

### FIELD OF THE INVENTION

This invention relates to a novel catalyst. In specific this invention relates to a novel catalyst that can be used in a process for converting one or more C3-C12 oxygenates. Further this invention relates to a method for preparation of such catalyst.

### BACKGROUND OF THE INVENTION

With increasing demand for liquid transportation fuels, decreasing reserves of ‘easy oil’ (crude petroleum oil that can be accessed and recovered easily) and increasing constraints on carbon footprints of such fuels, it is becoming increasingly important to develop routes to produce liquid transportation fuels from biomass in an efficient manner. Such liquid transportation fuels produced from biomass are sometimes also referred to as biofuels. Biomass offers a source of renewable carbon. Therefore, when using such biofuels, it may be possible to achieve more sustainable CO₂ emissions over petroleum-derived fuels.

WO2010/053681 describes a biofuel production process comprising amongst others converting biomass to alcohol, and synthesizing a liquid hydrocarbon fuel from the alcohol. WO2010/053681 describes several processes for converting the biomass to alcohol. WO2010/053681 further mentions that alcohols may be directly oligomerized to hydrocarbons apparently in the absence of hydrogen at high temperatures (300-450° C.) and moderate pressures (1-40 atm.) in the presence of a zeolite catalyst in an oligomerization reactor (see also FIG. 10 of WO2010/053681). It is further indicated that by controlling the temperature and pressure of the oligomerization process and/or the composition of the zeolite, it is possible to direct the production of longer or shorter chain hydrocarbons. WO2010/053681 further mentions that it is also possible to control the amount of alkane branching in the final product. In its example 1, 27 tonnes of secondary alcohols are oligomerized at 350° C. at 10 atm. in the presence of zeolite catalyst and oxygen to produce 17 tonnes of gasoline and water. The alcohol to gasoline conversion apparently involves also a hydrogenation step. The approximate yield of gasoline based on weight of alcohol feed may be calculated to be approximately 63 wt %.

In its example 5, 27 tonnes of mixed ketones are converted to approximately 28 tonnes of secondary alcohols by hydrogenation over a nickel catalyst at approximately 130° C. and 15 atm hydrogen. The 28 tonnes of secondary alcohols are oligomerized at 350° C. at 10 atm. in the presence of zeolite catalyst to produce 12 tonnes of gasoline, 5 tonnes of light hydrocarbon residuals and 20 tonnes of water. The approximate yield of gasoline based on weight of alcohol feed may be calculated to be approximately 42 wt %.

In his thesis titled “TRANSFORMATION OF ACETONE AND ISOPROPANOL TO HYDROCARBONS USING HZSM-5 CATALYST”, obtainable from the Office of Graduate Studies of the Texas A&M University, USA, (December 2009), S. T. Vasquez describes a transformation of acetone and isopropanol to hydrocarbons using a HZSM-5 catalyst. The thesis describes that zeolite solid-acid catalyst HZSM-5 can transform either alcohols or ketones into hydrocarbons. Catalysts having a Silica to Alumina molar Ratio (SAR) of 80 and 280 were used. Vasquez suggests for further studies to modify the catalyst HZSM-5 with metals such as Nickel or Copper.

In the processes of WO2010/053681 and Vasquez deactivation of the prior art catalysts may become an issue when the prior art processes would be applied on a commercial scale in a continuous manner. Without wishing to be bound by any kind of theory it is believed that operating the prior art processes for longer operating times may lead to excessive coking and subsequent deactivation of the catalysts.

For example Gayubo et al. in their article titled “Transformation of Oxygenate components of Biomass Pyrolysis Oil on a HZSM-5 Zeolite. I. Alcohols and Phenols”, published in Ind. Eng. Chem. Res. 2004, vol 43, page 2610 to 2618 and their article titled “Transformation of Oxygenate Components of Biomass Pyrolysis Oil on a HZSM-5 Zeolite. II. Aldehydes, Ketones, and Acids” published in Ind. Eng. Chem. Res. 2004, 43, 2619-2626 describe the effects of temperature and space time on the transformation over a HZSM-5 zeolite catalyst of several model components of the liquid product obtained by the flash pyrolysis of vegetable biomass (1-propanol, 2-propanol, 1-butanol, 2-butanol, phenol and 2-methoxyphenol). The HZSM-5 zeolite catalyst comprised 30 wt % bentonite, 45 wt % fused alumina and 25 wt % of a HZSM-5 zeolite having a Silica to Alumina molar Ratio of 24. They explain that the viability of transforming oxygenates into hydrocarbons was found to be limited by the catalyst deactivation by coke, and that this deactivation effects the product distribution with time on stream.

It would be an advancement in the art to provide a catalyst that can be used in a process for conversion of a feed containing one or more C3-C12 oxygenate(s), which catalyst can be used for a prolonged period of time without substantial deactivation of the catalyst.

### SUMMARY OF THE INVENTION

It has now been advantageously found that a feed containing one or more C3-C12 oxygenate(s) can be converted to a so-called middle distillate boiling product in a process operated for a prolonged period of time without substantial deactivation of the catalyst by using a specific catalyst.

Accordingly the present invention provides a sulphided carbon-carbon coupling catalyst comprising equal to or more than 60 wt % of a zeolite and in the range from equal to or more than 0.1 wt % to equal to or less than 10 wt % of a hydrogenation metal, based on the total weight of the carbon-carbon coupling catalyst; wherein the zeolite has 10-membered and/or 12-membered ring channels and a Silica to Alumina molar Ratio (SAR) in the range from equal to or more than 10 to equal to or less than 300.

By a 10-membered and/or 12-membered ring channel is herein preferably understood a ring channel comprising 10 respectively 12 tetrahedral atoms (such as silicon or aluminium atoms) in the ring.

It has now been found that such a catalyst may advantageously allow for an improved catalyst stability against deactivation due to coke formation and/or due to catalyst poisoning in a process for the conversion of one or more C3-C12 oxygenates into one or more middle distillate boiling products. Especially, such catalyst may advantageously allow for an improved stability under a hydrogen partial pressure of more than 1.0 MegaPascal (MPa).

Further the catalyst has been found suitable to allow for good yields of a middle distillate boiling product. This middle distillate boiling product may advantageously be used in the production of biofuels and/or biochemicals. By a middle distillate boiling product is herein preferably understood a product having a boiling point at 0.1 MegaPascal (MPa) in the range from equal to or more than 140° C. to equal to or less than 370° C. as determined by ASTM method D2887.

In addition, the catalyst may advantageously allow one to convert a feed containing two or more distinct C3-C12 oxygenates into a middle distillate boiling product having a smooth distillation curve.

Further, this invention provides a novel method for the preparation of the above catalyst and accordingly provides a method for the preparation of a carbon-carbon coupling catalyst comprising the steps of:

i) adding and/or suspending a zeolite, which zeolite comprises 10-membered and/or 12-membered ring channels and which zeolite has a Silica to Alumina Ratio (SAR) in the range from equal to or more than 10 to equal to or less than 300, into a aqueous metal salt solution, which aqueous metal salt solution comprises in the range from equal to or more than 0.5 to equal to or less than 3.0 mol of a hydrogenation metal per liter of water and which aqueous metal salt solution has a pH in the range from equal to or more than 5 to equal to or less than 10, wherein the zeolite is added and/or suspended in the aqueous metal salt solution in a ratio of grams zeolite to milliliters aqueous metal salt solution in the range from equal to or more than 0.05 to equal to or less than 0.33 grams of zeolite per milliliter of aqueous metal salt solution to produce a zeolite slurry;
ii) heating the zeolite slurry for a time period in the range from equal to or more than 30 minutes to equal to or less than 2 hours at a temperature in the range from equal to or more than 60° C. to equal to or less than 100° C. to produce a ion-exchanged zeolite slurry;
iii) cooling the ion-exchanged zeolite slurry to a temperature equal to or below 55° C. to produce a cooled ion-exchanged zeolite slurry;
iv) recovering the ion-exchanged zeolite from the cooled ion-exchanged zeolite slurry to produce a recovered ion-exchanged zeolite and optionally washing the recovered ion-exchanged zeolite;
v) drying the recovered ion-exchanged zeolite at a temperature in the range from equal to or more than 80° C. to equal to or less than 150° C. for a time period of equal to or more than 1 hour, preferably in air, to produce a dried ion-exchanged zeolite;
vi) calcining the dried ion-exchanged zeolite in air at a temperature in the range of from equal to or more than 400° C. to equal to or less than 600° C. for a time period in the range from 30 minutes to 12 hours to produce a calcined ion-exchanged zeolite;
vii) extruding the calcined ion-exchanged zeolite with a binder and/or a filler in a weight ratio of weight calcined ion-exchanged zeolite to total weight of any binder and/or any filler in the range from equal to or more than 60:40 to equal to or less than 80:20 to produce an extrudate;
viii) re-calcining the extrudate at a temperature in the range from equal to or more than 400° C. to equal to or less than 550° C. for a time period in the range from 30 minutes to 12 hours to produce a carbon-carbon coupling catalyst.

### SUMMARY OF THE DRAWINGS

The invention is further illustrated by the following non-limiting drawings:

FIG. 1 illustrates a boiling point distribution as determined by ASTM method D2887 of two products obtained with two examples of catalysts according to the invention.

### DETAILED DESCRIPTION OF THE INVENTION

The carbon-carbon coupling catalyst according to the invention may herein below sometimes also be referred to as conversion catalyst. By a carbon-carbon coupling catalyst is herein preferably understood a catalyst that is capable of coupling two compounds, each of which compounds contains at least carbon and hydrogen, via a carbon-carbon bond under conditions suitable therefore. An example of a carbon-carbon coupling catalyst is a so-called oligomerization catalyst.

By a 10-membered respectively a 12-membered ring channel is herein preferably understood a channel defined by rings having 10 tetrahedral atoms respectively having 12 tetrahedral atoms in the ring. Examples of tetrahedral atoms include silicon and aluminium. The zeolite may contain 10-membered ring channels, 12-membered ring channels or a combination thereof. In addition to the 10-membered ring channels and/or 12-membered ring channels the zeolite may contain additional ring channels having a different number of tetrahedral atoms in the ring, preferably such additional ring channels are ring channels having less than 10 tetrahedral atoms in the ring.

The ring channels may for example be arranged in a one-dimensional, two-dimensional or three-dimensional network.

In one embodiment the zeolite is preferably a zeolite that has a Silica to Alumina molar Ratio (SAR) in the range from equal to or more than 10 to equal to or less than 100 before modification with a hydrogenation metal, and more preferably a zeolite that has a SAR in the range from equal to or more than 10 to equal to or less than 40 before modification with a hydrogenation metal. A carbon-carbon coupling catalyst with a zeolite having a SAR in these ranges before modification with a metal advantageously allows for improved stability of the catalyst towards deactivation. In addition the use of a carbon-carbon coupling catalyst with a zeolite having a SAR in these ranges may advantageously result in a good yield of so-called middle distillate boiling products.

In another embodiment the zeolite preferably has a Silica to Alumina molar Ratio (SAR) in the range from equal to or more than 250 to equal to or less than 300 before modification with a hydrogenation metal. The use of a carbon-carbon coupling catalyst with a zeolite having a SAR in these ranges may advantageously result in a good yield of gasoline products.

Preferably the zeolite is a zeolite chosen from the group consisting of MFI-type zeolites, FER-type zeolites, BEA-type zeolites, MOR-type zeolites, FAU type zeolites and combinations thereof. By a certain type of zeolite, such as for example an MFI-type zeolite, is herein preferably understood a zeolite with a certain framework type, such as for example a zeolite with an MFI-framework type. These different zeolite framework types are for example defined in the “Atlas of Zeolite Framework types”, sixth revised edition, published by Elsevier B.V. in 2007. Preferred examples of zeolites that can be comprised in the carbon-carbon coupling catalyst include ZSM-5, Mordenite zeolite, zeolite Beta, Y-zeolite or combinations thereof.

The carbon-carbon coupling catalyst further comprises a hydrogenation metal. The carbon-carbon coupling catalyst may comprise one or more hydrogenation metals. Preferably the carbon-carbon coupling catalyst comprises one or more hydrogenation metals chosen from the group consisting of copper, molybdenum, tungsten, cobalt and nickel. In addition the carbon-carbon coupling catalyst may comprise one or more other hydrogenation metals. More preferably the carbon-carbon coupling catalyst only contains hydrogenation metals chosen from the group consisting of nickel, cobalt, molybdenum, copper, tungsten and combinations thereof.

The carbon-carbon coupling catalyst preferably comprises in the range from equal to or more than 0.5 wt % to equal to or less than 10 wt % hydrogenation metal, based on the total weight of the carbon-carbon coupling catalyst. More preferably the carbon-carbon coupling catalyst comprises in the range from equal to or more than 0.5 wt % to equal to or less than 5 wt % of the hydrogenation metal, based on the total weight of the carbon-carbon coupling catalyst. Most preferably the carbon-carbon coupling catalyst comprises in the range from equal to or more than 1.0 wt % to equal to or less than 3.5 wt % of the hydrogenation metal, based on the total weight of the carbon-carbon coupling catalyst.

For practical purposes the weight percentages of hydrogenation metal and/or the zeolite as specified herein are best determined based on the total weight of the carbon-carbon coupling catalyst before sulphiding of the catalyst.

In addition to the zeolite and the hydrogenation metal, the carbon-carbon coupling catalyst may optionally comprise one or more binders and/or fillers. An example of a binder is silica sol. Examples of fillers include amorphous alumina, amorphous silica, or amorphous silica-alumina, boehmite alumina (AlOOH), natural or synthetic clays, pillared or delaminated clays, or mixtures of one or more of these. Examples of clays include kaolin, hectorite, sepiolite and attapulgite.

Preferably the carbon-carbon coupling catalyst comprises equal to or more than 70 wt %, more preferably equal to or more than 80 wt %, possibly even as high as equal to or more than 90 wt %, of the zeolite, based on the total weight of the carbon-carbon coupling catalyst. More preferably the carbon-carbon coupling catalyst comprises in the range from equal to or more than 60.0 wt % to equal to or less than 99.9 wt %, even more preferably in the range from equal to or more than 70.0 wt % to equal to or less than 95.0 wt %, still more preferably in the range from equal to or more than 70.0 wt % to equal to or less than 85.0 wt % of the zeolite, based on the total weight of the carbon-carbon coupling catalyst. The balance may consist of one or more hydrogenation metals and/or one or more binders and/or fillers.

The carbon-carbon coupling catalyst may be prepared in any manner known to be suitable to the skilled person in the art to prepare a catalyst comprising a zeolite and a hydrogenation metal as described above. For example the carbon-carbon coupling catalyst may be prepared by ion-exchange of the zeolite with an aqueous metal salt solution containing the hydrogenation metal; deposition of the hydrogenation metal on the zeolite by means of impregnation; and/or co-mulling of the zeolite and the hydrogenation metal.

In a preferred embodiment the carbon-carbon coupling catalyst is prepared by ion-exchange of the zeolite with an aqueous solution containing one or more salts of one or more hydrogenation metals. Preferably the one or more hydrogenation metal(s) is/are one of the preferred hydrogenation metals as described above. As indicated above, the most preferred hydrogenation metals include nickel, cobalt, molybdenum, copper, tungsten and combinations thereof. In addition, the carbon-carbon coupling catalyst may contain for example ruthenium and/or iron. The aqueous solution containing one or more salts of one or more hydrogenation metals is herein also abbreviated as “metal salt solution”. Preferably the metal salt solution is prepared by dissolving the one or more hydrogenation metal salts in deionized water. Preferably the metal salt solution has a concentration in the range from equal to or more than 0.5 mol hydrogenation metal/liter water to equal to or less than 3 mol hydrogenation metal/liter water. Before carrying out the ion-exchange, the pH of the metal salt solution is preferably adjusted to a pH in the range from equal to or more than 5 to equal to or less than 10, preferably by addition of an ammonium containing solution or by the addition of aqueous ammonia.

Preferences for the zeolite are as described above. In one embodiment the zeolite preferably has a SAR in the range from equal to or more than 10 to equal to or less than 100, more preferably in the range from equal to or more than 10 to equal to or less than 40, before it is contacted with the hydrogenation metal. Preferably the zeolite before ion exchange with the metal salt solution, is a zeolite in the ammonium form. A zeolite in the ammonium form can for example be obtained by exchanging any known non-ammonium cations (such as H+ or Na+) by an ammonium ion or by precipitating the zeolite in the ammonium form.

Preferably the zeolite is a zeolite powder comprising crystalline particles, which crystalline particles have a particle size distribution with an average particle size in the range from 0.05 micrometers to 10 micrometers. These crystalline particles can agglomerate into bigger particles. The particle size can for example be determined by a laser scattering particle size distribution analyzer.

The ion exchange is preferably started by adding and/or suspending the zeolite, preferably a zeolite powder in the ammonium form, to the metal salt solution in a ratio of millilitres metal salt solution to grams of zeolite in the range from equal to or more than 3 ml to equal to or less than 20 ml metal salt solution per gram of zeolite. By adding and/or suspending the zeolite into the metal salt solution a slurry of zeolite in the metal salt solution (herein also referred to as “zeolite slurry”) can be formed, which zeolite slurry preferably comprises in the range from equal to or more than 0.05 to equal to or less than 0.33 gram zeolite per millilitre of metal salt solution.

The ion exchange can subsequently be carried out by heating the zeolite slurry, preferably for a time period in the range from equal to or more than 30 minutes to equal to or less than 2 hours and preferably at a temperature in the range from equal to or more than 60° C. to equal to or less than 100° C. Preferably the zeolite slurry is heated via refluxing. Hereafter the zeolite slurry may be cooled, for example to a temperature of equal to or less than 55° C., more preferably to a temperature in the range from equal to or more than 18° C. to equal to or less than 55° C., more preferably to a temperature of about 50° C. to produce a cooled zeolite slurry. From the cooled zeolite slurry an ion-exchanged zeolite can be recovered, for example by filtering.

The recovered ion-exchanged zeolite may suitably be washed one or more times with water to remove any free metal compounds from it. For example after filtration the filter residue (sometimes also referred to as filter cake) may suitably be washed with water. Hereafter the recovered ion-exchanged zeolite may be dried, preferably at a temperature in the range from equal to or more than 80° C. to equal to or less than 150° C., more preferably at a temperature in the range from equal to or more than 100° C. to equal to or less than 150° C., preferably in air, and preferably for a time period of equal to or more than 1 hours, more preferably for a time period in the range from equal to or more than 2 hours to equal to or less than 20 hours to produce a dried ion-exchanged zeolite. The, suitably dried, ion-exchanged zeolite is preferably calcined in air at a temperature in the range from equal to or more than 400° C. to equal to or less than 600° C., preferably for a time period in the range from 30 minutes to 12 hours, more preferably for a time period in the range from 1 hours to 12 hours, to produce a calcined ion-exchanged zeolite (herein also referred to as first calcination). Preferably the calcined ion-exchanged zeolite is subsequently mixed with a binder, preferably in a weight ratio of calcined ion-exchanged zeolite to binder in the range from equal to or more than 60:40 to equal to or less than 90:10, more preferably equal to or less than 80:20. In a preferred embodiment the calcined-ion exchanged zeolite and the binder are shaped into extrudates. The extrudates may suitably be re-calcined, preferably at the same or a lower temperature than the first calcination, more preferably at a temperature in the range from equal to or more than 400° C. to equal to or less than 550° C. preferably for a time period in the range from 30 minutes to 12 hours, more preferably for a time period in the range from 1 hours to 12 hours, (herein also referred to as second calcination) to produce a carbon-carbon coupling catalyst. The calcination and/or re-calcination can suitably be carried out batch-wise, where the time period refers to holding time; or continuously, where the time period refers to residence time.

The present invention therefore also provides a method for the preparation of a carbon-carbon coupling catalyst

The carbon-carbon coupling catalyst may for example be prepared by a process comprising the steps of:

i) adding and/or suspending a zeolite, which zeolite comprises 10-membered and/or 12-membered ring channels and which zeolite has a Silica to Alumina molar Ratio (SAR) in the range from equal to or more than 10 to equal to or less than 300, into an aqueous metal salt solution, which aqueous metal salt solution comprises in the range from equal to or more than 0.5 to equal to or less than 3.0 mol of a hydrogenation metal per liter of water and which aqueous metal salt solution has a pH in the range from equal to or more than 5 to equal to or less than 10, wherein the zeolite is added and/or suspended in the aqueous metal salt solution in a ratio of grams zeolite to millilitres aqueous metal salt solution in the range from equal to or more than 0.05 to equal to or less than 0.33 grams of zeolite per millilitre of aqueous metal salt solution to produce a zeolite slurry;
ii) heating the zeolite slurry for a time period in the range from equal to or more than 30 minutes to equal to or less than 2 hours at a temperature in the range from equal to or more than 60° C. to equal to or less than 100° C. to produce a ion-exchanged zeolite slurry;
iii) cooling the ion-exchanged zeolite slurry to a temperature equal to or below 55° C. to produce a cooled ion-exchanged zeolite slurry;
iv) recovering the ion-exchanged zeolite from the cooled ion-exchanged zeolite slurry to produce a recovered ion-exchanged zeolite and optionally washing the recovered ion-exchanged zeolite;
v) drying the recovered ion-exchanged zeolite at a temperature in the range from equal to or more than 80° C. to equal to or less than 150° C. for a time period of equal to or more than 1 hour, preferably in air, to produce a dried ion-exchanged zeolite;
vi) calcining the dried ion-exchanged zeolite in air at a temperature in the range of from equal to or more than 400° C. to equal to or less than 600° C. for a time period in the range from 30 minutes to 12 hours to produce a calcined ion-exchanged zeolite;
vii) extruding the calcined ion-exchanged zeolite with a binder and/or a filler in a weight ratio of weight calcined ion-exchanged zeolite to total weight of any binder and/or any filler in the range from equal to or more than 60:40 to equal to or less than 90:10, preferably to equal to or less than 80:20, to produce an extrudate;
viii) re-calcining the extrudate at a temperature in the range from equal to or more than 400° C. to equal to or less than 550° C. for a time period in the range from 30 minutes to 12 hours to produce a carbon-carbon coupling catalyst.

The produced carbon-carbon coupling catalyst may subsequently be sulphided to produce the sulphided carbon-carbon coupling catalyst. Preferences for such sulphiding are described herein below.

The carbon-carbon coupling catalyst may suitably be used in a process wherein a feed comprising one or more C3-C12 oxygenates is converted. In a preferred embodiment, the carbon-carbon coupling catalyst is used in a process for converting one or more C3-C12 oxygenates comprising:

contacting a feed, which feed comprises one or more C3-C12 oxygenates, with hydrogen at a hydrogen partial pressure of more than 1.0 MegaPascal in the presence of a sulphided carbon-carbon coupling catalyst. Preferably the hydrogen is provided at a hydrogen to liquid ratio in the range from equal to or more than 200 to equal to or less than 5000, more preferably in the range from equal to or more than 400 to equal to or less than 2000 N1 H₂/kg feed (normal liter hydrogen per kg feed, where a normal liter is understood to refer to a liter of gas at a pressure of 0.1 MPa (MegaPascal) and at a temperature of 20° C.)

By an oxygenate is herein understood a compound comprising at least one or more carbon atoms, at least one or more hydrogen atoms and at least one or more oxygen atoms. Examples of oxygenates include alkanols, ketones, aldehydes, carboxylic acids, ethers, esters and/or phenolic compounds.

Preferably the one or more oxygenates herein referred to consist of one or more aldehydes, one or more alkanols, one or more ketones and/or combinations thereof. More preferably the one or more oxygenates herein referred to consist of one or more ketones. For example, the one or more C3-C12 oxygenates referred to herein preferably consist of one or more C3-C12 ketones. By a “Cx”-oxygenate, -alkanol, -ketone and/or -aldehyde is herein understood respectively an oxygenate, alkanol, ketone and/or aldehyde, comprising x carbon atoms. By a “Cx-Cy”-oxygenate, -alkanol, -ketone and/or -aldehyde is herein understood respectively an oxygenate, alkanol, ketone and/or aldehyde comprising in the range from equal to or more than “x” to equal to or less than “y” carbon atoms.

Examples of suitable alkanols include primary, secondary, linear, branched and/or cyclic alkanols, such as methanol, ethanol, 1-propanol, 2-propanol, 1-butanol, 2-butanol, pentanol, cyclopentanol, hexanol, cyclohexanol, 2-methyl-cyclopentanonol, heptanol, octanol, nonanol, decanol, undecanol, dodecanol, ethylene glycol, propylene glycol, 1,3-propanediol, butanediol, pentanediol, hexanediol, heptanediol, octanediol, nonanediol, decanediol, undecanediol, dodecanediol and/or isomers thereof.

Examples of suitable ketones include hydroxyketones, oxo-aldehydes, cyclic ketones and/or diketones, for example chosen from the group consisting of acetone, propanone, 2-oxopropanal, butanone, butane-2,3-dione, 3-hydroxybutane-2-one, pentanone, cyclopentanone, pentane-2,3-dione, pentane-2,4-dione, pentatrione, hexanone, hexane-2,3-dione, hexane-2,4-dione, hexane-2,5-dione, hexane-3,4-dione, hexane-triones, cyclohexanone, 2-methyl-cyclopentanone, heptanones, octanones, nonanones, decanones, undecanones, dodecanones, 2-oxo-propanal, 2-oxo-butanal, 3-oxo-butanal, isomers thereof and or mixtures thereof.

Examples of suitably aldehydes include acetaldehyde, propionaldehyde, butyraldehyde, pentanal, hexanal, heptanal, octanal, nonal, decanal, undecanal, dodecanal and/or isomers thereof.

The catalyst according to the invention is further especially advantageous when used to convert a feed containing a plurality of two or more C3-C12 oxygenates or a plurality of three or more C3-C12 oxygenates. It has advantageously been found that even when a plurality of two or more distinctive C3-C12 oxygenates, or a plurality of three or more distinctive C3-C12 oxygenates, is contacted with the catalyst, still a middle distillate boiling product can be obtained that has a smooth boiling range distribution. By two or more distinctive oxygenates is herein for example understood two or more C3-C12 oxygenates comprising different numbers of carbon atoms.

The carbon-carbon coupling catalyst may suitably be sulphided ex-situ (i.e. outside the process) or in-situ (i.e. during the process) or both to produce a sulphided carbon-carbon coupling catalyst.

In one preferred embodiment the catalyst is sulphided by a liquid phase sulphiding procedure. In such a liquid phase sulphiding procedure the catalyst is contacted with a liquid containing in the range from equal to or more 0.1 wt % to equal to or less than 3.5 wt % of sulphur, more preferably in the range from equal to or more than 1.5 wt % to equal to or less than 3.5 wt % of sulphur at a temperature in the range from equal to or more than 200° C. to equal to or less than 400° C., more preferably at a temperature in the range from equal to or more than 300° C. to equal to or less than 380° C., in the presence of hydrogen.

The sulphur-containing liquid can for example be a feed containing one or more C3-C12 oxygenates, which may be spiked with sulphur, or for example a hydrocarbon containing liquid that additionally contains sulphur.

A preferred example of such a hydrocarbon containing liquid that additionally contains sulphur is a so-called straight run gasoil containing sulphur. Conveniently the liquid phase sulphiding with such a hydrocarbon containing liquid that additionally contains sulphur may be carried out in a reactor, where the carbon-carbon coupling catalyst is first sulphided in the reactor by contacting it with the hydrocarbon-containing liquid and subsequently the hydrocarbon-containing liquid is replaced by a feed comprising the one or more C3-C12 oxygenates.

In another preferred embodiment the catalyst is sulphided by spiking the feed comprising one or more C3-C12 oxygenates with sulphur containing compounds to produce a feed containing in the range from equal to or more than 0.1 wt % to equal to or less than 0.2 wt % sulphur and preferably maintaining this sulphur level throughout the process. Examples of such one or more sulphur containing compounds include dimethyldisulphide (DMDS) or SULFRZOL® 54 (SULFRZOL® 54 is a trademark, the sulphur containing compound is commercially available from Lubrizol).

In a further preferred embodiment sulphiding of the catalyst can be accomplished by gas-phase sulphiding with a H₂S/H₂ mixture as the sulfiding medium. Such a H₂S/H₂ mixture preferably comprises in the range from 0.1 and 5 vol % H₂S based on the total volume of the H₂S/H₂ mixture.

One skilled in the art will understand that a combination of the above preferred sulphiding embodiments is also possible.

In a preferred embodiment the sulphided catalyst is kept in the sulphided state by using it in a process in the presence of hydrogensulphide. The hydrogensulphide may be provided as such or may be generated in-situ by hydrogenation of the feed or a co-feed. In a preferred embodiment the hydrogensulphide may be generated by spiking the feed with one or more sulphur containing compounds. Preferably the feed may be spiked with an amount of sulphur in the range form equal to or more than 0.1 wt % to equal to or less than 0.2 wt %. Examples of such one or more sulphur containing compounds include dimethyldisulphide (DMDS) or SULFRZOL® 54 (SULFRZOL® 54 is a trademark, the sulphur containing compound is commercially available from Lubrizol).

### EXAMPLES

### Examples 1a and 1b

### Conversion of a Mixed Ketone Feed in a Stacked Bed Containing a Nickel-Exchanged Mordenite Zeolite Catalyst (Carbon-Carbon Coupling Catalyst A) and a Hydrotreatment Catalyst

A powder of mordenite zeolite with an ammonium form and an SiO2:Al2O3 molar ratio (SAR) of approximately 20 was obtained commercially from Zeolyst International. An aqueous solution of 1 mol/liter nickel (II) nitrate hexahydrate was prepared and the pH of the solution was adjusted to 6 using ammonium hydroxide. The powder of mordenite zeolite was suspended in nickel nitrate solution in an amount of about 10 ml of nickel nitrate solution to about 1 gram of mordenite powder and the slurry was vigorously agitated using a stirrer or impeller to get a uniform suspension. Subsequently the temperature of the slurry was raised to 95° C. while refluxing and then maintained at 95° C. for 1 hour. The slurry was vigorously agitated using a stirrer or impeller during the whole of the ion-exchange step. Hereafter the slurry was cooled to 50° C., filtered to recover nickel-exchanged mordenite powder and washed with water. The recovered nickel-exchanged mordenite powder was calcined at a temperature of 500° C. for 2 hours. Extrudates were prepared by mixing CATAPAL-D boehmite alumina (CATAPAL is a trademark, CATAPAL-D boehmite alumina is commercially obtainable from Sasol) in a ratio of 80 wt % nickel-exchanged Mordenite to 20 wt % alumina (80:20). The obtained extrudates were re-calcined at 500° C. during 2 hours. The prepared nickel-exchanged mordenite zeolite catalyst contained about 1.5 wt % nickel on the basis of the total weight of the catalyst (carbon-carbon coupling catalyst A).

The prepared 1.5 wt % nickel-exchanged mordenite zeolite catalyst (carbon-carbon coupling catalyst A) was loaded into a stacked bed configuration in a reactor. The stacked bed configuration consisted of a top catalyst bed consisting of the carbon-carbon coupling catalyst A and a bottom catalyst bed comprising a nickel-molybdenum hydrotreating catalyst containing about 18 wt % molybdenum, about 6 wt % nickel and about 3 wt % phosphor on alumina (herein also referred to as 6Ni-18Mo/Al) in a weight ratio of carbon-carbon coupling catalyst A to nickel-molybdenum hydrotreating catalyst of about 1.95:1. In this configuration the top catalyst bed was located upstream of the bottom catalyst bed.

After the catalysts were loaded in the reactor, they were sulphided with a gasoil spiked with dimethyldisulphide (DMDS) to have a sulphur content of 2.5 wt % using a liquid phase sulphiding procedure by exposing the catalyst to the sulphur-containing gasoil and hydrogen at a temperature of about 345° C. for a period of about 12 hours at a pressure of 12 MPa.

After sulphiding of the catalysts, a feed containing a mixture of ketones having predominantly 3 to 11 carbon atoms as illustrated in table 1 (hereafter also referred to as “mixed ketone feed”) was contacted with the catalysts at the conditions summarized in table 2 for examples 1a and 1b. The feed containing the mixture of ketones was derived from the fermentation of food waste (a mixture of animal and plant derived lignocellulosic biomass, proteins, fats and oils etc.). The mixed ketone feed had a total sulphur content of about 391 ppmw and a total nitrogen content of about 3350 ppmw, out of which the basic nitrogen content was about 914 ppmw. The mixed ketone feed was spiked with DMDS to increase its sulfur content to about 0.1% wt. After contacting the mixed ketone feed with the catalysts, reactor effluent was collected.

A liquid hydrocarbon product was separated from the reactor effluent. Product characteristics for the liquid hydrocarbon product obtained are listed in table 3 for examples 1a and 1b.

In the below tables, the abbreviation “CCC cat.” refers to the “carbon-carbon coupling catalyst”; and the abbreviation “HT cat.” refers to the “hydrotreatment catalyst”.

TABLE 1
Mixed Ketone Feed Composition

| Component | Wt % |
|---|---|
| Acetone | 14.64 |
| 2-butanone | 18.19 |
| 3-butanone, 3- | 0.90 |
| methyl | |
| 2-pentanone | 22.53 |
| Methyl isobutyl | 2.76 |
| ketone | |
| 3-hexanone | 4.70 |
| 2-hexanone | 6.81 |
| 4-heptanone | 1.80 |
| 3-heptanone | 1.42 |
| 2-heptanone | 4.18 |
| 4-octanone | 1.02 |
| 3-octanone | 0.84 |
| 2-octanone | 0.93 |
| 4-nonanone | 0.64 |
| 3-Nonanone | 0.22 |
| 2-Nonanone | 0.18 |
| 4-decanone | 0.18 |
| 3-decanone | 0.03 |
| 2-decanone | 0.07 |
| 6-undecanone | 0.08 |

### Examples 2a and 2b

### Conversion of a Mixed Ketone Feed in a Stacked Bed Containing a Cobalt-Exchanged Mordenite Zeolite Catalyst (Carbon-Carbon Coupling Catalyst B) and a Hydrotreatment Catalyst

A powder of mordenite zeolite with an ammonium form and an SiO2:Al2O3 molar ratio (SAR) of approximately 20 was obtained commercially from Zeolyst International. An aqueous solution of 1 mol/liter cobalt (II) nitrate hexahydrate was prepared and the pH of the solution was adjusted to 6 using ammonium hydroxide. The powder of mordenite zeolite was suspended in cobalt nitrate solution in an amount of about 10 ml of cobalt nitrate solution to about 1 gram of mordenite powder and the slurry was vigorously agitated using a stirrer or impeller to get a uniform suspension. Subsequently the temperature of the slurry was raised to 95° C. while refluxing and then maintained at 95° C. for 1 hour. The slurry was vigorously agitated using a stirrer or impeller during the whole of the ion-exchange step. Hereafter the slurry was cooled to 50° C., filtered to recover cobalt-exchanged mordenite powder and washed with water.

The recovered cobalt-exchanged mordenite powder was calcined at a temperature of 500° C. for 2 hours. Extrudates were prepared by mixing CATAPAL-D boehmite alumina (CATAPAL is a trademark, CATAPAL-D boehmite alumina is commercially obtainable from Sasol) in a ratio of 80 wt % cobalt-exchanged mordenite to 20 wt % alumina (80:20). The obtained extrudates were re-calcined at 500° C. during 2 hours. The prepared cobalt-exchanged mordenite zeolite catalyst contained about 2 wt % cobalt on the basis of the total weight of the catalyst (carbon-carbon coupling catalyst B).

The prepared 2 wt % cobalt-exchanged mordenite zeolite catalyst (carbon-carbon coupling catalyst B) was loaded into a stacked bed configuration in a reactor. The stacked bed configuration consisted of a top catalyst bed consisting of the carbon-carbon coupling catalyst B and a bottom catalyst bed comprising the same nickel-molybdenum hydrotreating catalyst as used in examples 1a and 1b in a weight ratio of carbon-carbon coupling catalyst B to nickel-molybdenum hydrotreating catalyst of 1.87:1. The top catalyst bed was located upstream of the bottom catalyst bed.

After the catalysts were loaded in the reactor, they were sulphided with a gasoil spiked to have a sulphur content of 2.5 wt % using a liquid phase sulphiding procedure by exposing the catalyst to the sulphur-containing gasoil and hydrogen at a temperature of about 345° C. for a period of about 12 hours at a pressure of 12 MPa. Dimethyldisulphide (DMDS) was used to spike the gasoil with sulfur to obtain a sulfur content of 2.5 wt %.

After sulphiding of the catalysts, a feed identical to that in examples 1a and 1b, containing a mixture of ketones having predominantly 3 to 11 carbon atoms as illustrated in table 1, was contacted with the catalysts at the conditions summarized in table 2 for examples 2a and 2b.

After contacting the mixed ketone feed with the catalysts, reactor effluent was collected.

A liquid hydrocarbon product was separated from the reactor effluent. Product characteristics for the liquid hydrocarbon product obtained are listed in table 3 for examples 2a and 2b.

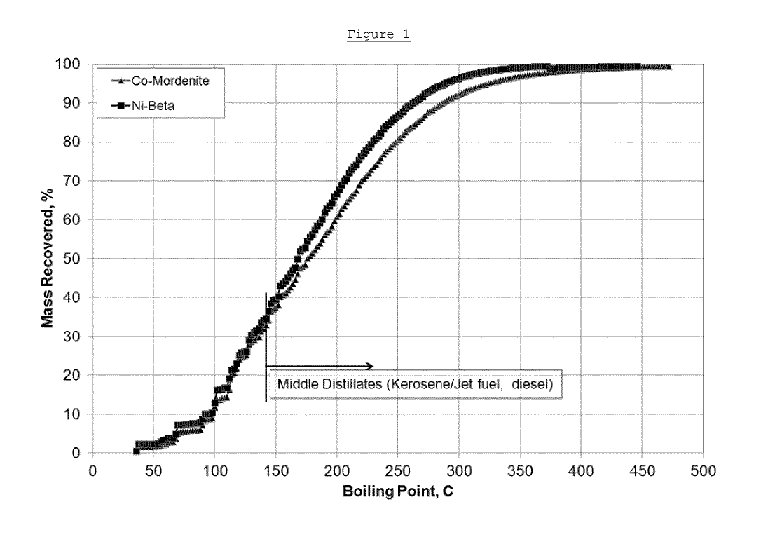

The boiling point distribution of the liquid hydrocarbon product obtained in example 2b (using a reaction temperature of 350° C.) was analyzed according to ASTM method D2887. The result is illustrated in FIG. 1. As can be seen in FIG. 1, the obtained boiling curve is smooth in the boiling range from 130° C. to 370° C. A smooth boiling point distribution, or lack of distinctive steps in such a boiling point distribution, is advantageous to achieve a suitable product specification (such as Jet A1 or JP8) for use in jet fuel.

### Examples 3a and 3b

### Conversion of a Mixed Ketone Feed in a Stacked Bed Containing a Nickel-Exchanged Zeolite Beta Catalyst (Carbon-Carbon Coupling Catalyst C) and a Hydrotreatment Catalyst

A powder of zeolite Beta with an ammonium form and an SiO2:Al2O3 molar ratio (SAR) of approximately 20 was obtained commercially from Zeolyst International. An aqueous solution of 1 mol/liter nickel (II) nitrate hexahydrate was prepared and the pH of the solution was adjusted to 6 using ammonium hydroxide. The zeolite Beta powder was suspended in the nickel nitrate solution in an amount of about 10 ml of nickel nitrate solution to about 1 gram of zeolite Beta powder and the slurry was vigorously agitated using a stirrer or impeller to get a uniform suspension. Subsequently the temperature of the slurry was raised to 95° C. while refluxing and then maintained at 95° C. for 1 hour. The slurry was vigorously agitated using a stirrer or impeller during the whole of the ion-exchange step. Hereafter the slurry was cooled to 50° C., filtered to recover nickel-exchanged zeolite Beta powder and washed with water.

The recovered nickel-exchanged zeolite Beta powder was calcined at a temperature of 500° C. for 2 hours. Extrudates were prepared by mixing CATAPAL-D boehmite alumina (CATAPAL is a trademark, CATAPAL-D boehmite alumina is commercially obtainable from Sasol) in a ratio of 80 wt % nickel-exchanged zeolite Beta to 20 weight % alumina (80:20). The obtained extrudates were re-calcined at 500° C. during 2 hours. The prepared nickel-exchanged zeolite Beta catalyst contained about 1.8 wt % nickel on the basis of the total weight of the catalyst (carbon-carbon coupling catalyst C).

The prepared 1.8 wt % nickel-exchanged zeolite Beta catalyst (carbon-carbon coupling catalyst C) was loaded into a stacked bed configuration in a reactor. The stacked bed configuration consisted of a top catalyst bed consisting of the carbon-carbon coupling catalyst C and a bottom catalyst bed comprising the same nickel-molybdenum hydrotreating catalyst as used in examples 1a and 1b in a weight ratio of carbon-carbon coupling catalyst C to nickel-molybdenum hydrotreating catalyst of 1.59:1. The top catalyst bed was located upstream of the bottom catalyst bed.

After the catalysts were loaded in the reactor, they were sulphided with a gasoil spiked with dimethyldisulphide (DMDS) to have a sulphur content of 2.5 wt % using a liquid phase sulphiding procedure by exposing the catalyst to the sulphur-containing gasoil and hydrogen at a temperature of about 345° C. for a period of about 12 hours at a pressure of 12 MPa.

After sulphiding of the catalysts, a feed identical to that in examples 1a and 1b, containing a mixture of ketones having predominantly 3 to 11 carbon atoms as illustrated in table 1 was contacted with the catalysts at the conditions summarized in table 2 for examples 3a and 3b.

A liquid hydrocarbon product was separated from the reactor effluent. Product characteristics for the liquid hydrocarbon product obtained are listed in table 3 for examples 3a and 3b.

The boiling point distribution of the liquid hydrocarbon product obtained in example 3b (i.e. using a reaction temperature of 350° C.) was analyzed according to ASTM method D2887. The result is illustrated in FIG. 1. As can be seen in FIG. 1, the obtained boiling curve is smooth in the boiling range from 130° C. to 370° C.

A smooth boiling point distribution, or lack of distinctive steps in such a boiling point distribution, is advantageous to achieve suitable product specification (such as Jet A1 or JP8) for use in a jet fuel.

TABLE 2
Process Conditions for Examples 1a, 1b, 2a, 2b, 3a and 3b (All
on a Single Pass Basis without any Gas or Liquid Recycle)

| Example | la | 1b | 2a | 2b | 3a | 3b |
|---|---|---|---|---|---|---|
| CCC cat. (SAR) | A (20) | A (20) | B (20) | B (20) | C (20) | C (20) |
| HT cat. | sulphided | sulphided | sulphided | sulphided | sulphided | sulphided |
| | 6Ni—18Mo/Al | 6Ni—18Mo/Al | 6Ni—18Mo/Al | 6Ni—18Mo/Al | 6Ni—18Mo/Al | 6Ni—18Mo/Al |
| Weight ratio | 1.95:1 | 1.95:1 | 1.87:1 | 1.87:1 | 1.59:1 | 1.59:1 |
| CCC cat.:HT cat. | | | | | | |
| WHSV CCC cat. | 0.53 | 0.53 | 0.54 | 0.54 | 0.61 | 0.61 |
| (kg liquid | | | | | | |
| feed/kg cat · hr) | | | | | | |
| WHSV HT cat. | 1.03 | 1.03 | 1.01 | 1.01 | 0.97 | 0.97 |
| (kg liquid | | | | | | |
| feed/kg cat · hr) | | | | | | |
| Temperature (° C.) | 300 | 350 | 300 | 350 | 300 | 350 |
| Pressure (MPa) | 12 | 12 | 12 | 12 | 12 | 12 |
| Hydrogen to | 582 | 582 | 557 | 557 | 622 | 622 |
| feed ratio | | | | | | |
| (Nl H2/kg feed) | | | | | | |

TABLE 3
Product Characteristics for the Liquid Hydrocarbon
Product in Examples 1a, 1b, 2a, 2b, 3a and 3b

| Example | 1a | 1b | 2a | 2b | 3a | 3b |
|---|---|---|---|---|---|---|
| Oxygen content of | 3.0 | 1.5 | 2.3 | 0.85 | <1.0 | 0.5 |
| the liquid | | | | | | |
| hydrocarbon | | | | | | |
| product (wt %) | | | | | | |
| Smooth boiling | 140 | 140 | 140 | 140 | 140 | 140 |
| above (° C.) | | | | | | |
| 140° C.-370° C. | 15 | 23 | 15 | 21 | 17 | 23 |
| boiling range | | | | | | |
| fraction* (wt % | | | | | | |
| based on weight of | | | | | | |
| mixed ketone feed) | | | | | | |
| C5-140° C. boiling | 55 | 48 | 53.5 | 47 | 53 | 48.5 |
| range fraction* | | | | | | |
| (wt % based on | | | | | | |
| weight of mixed | | | | | | |
| ketone feed) | | | | | | |

*boiling fractions are based on ASTM D2887 SIMDIS method.

### Example 4

### Properties of the Liquid Hydrocarbon Product

This example illustrates the ability to alter the properties of a liquid hydrocarbon product produced, by altering the strength of a hydrogenation function of the catalyst. In a first variation, a carbon-carbon coupling catalyst with high hydrogenation activity, namely a nickel-exchanged mordenite zeolite catalyst containing about 1.5 wt % nickel (carbon-carbon coupling catalyst A), was used as the top catalyst in a stacked bed and subjected to sulphurization. A high activity sulphided hydrotreatment catalyst containing about 18 wt % molybdenum, about 5 wt % nickel and about 3 wt % phosphor on an alumina support was used as a bottom catalyst in the same stacked bed, with the volume ratio of carbon-carbon coupling catalyst to hydrotreating catalyst being 1.5:1. The overall WHSV was 0.33 (kg liquid feed/lit cat.hr). Average catalyst bed temperature was 360° C. and reactor pressure was about 12 MPa. A mixed ketone feed as illustrated in table 1 was contacted with the catalysts. The hydrocarbon liquid product produced from a mixed ketone feed having composition as shown in Table 1 was separated from the aqueous layer, and distilled following the ASTM D2892 distillation method. The 140° C. to 250° C. boiling range fraction from this distillation, which represents a kerosene or jet fuel boiling range fraction of the hydrocarbon liquid, was analyzed for density and aromatics. This 140° C. to 250° C. boiling range fraction was found to have a density of 0.77 g/mL, and an aromatic content of about 11.5 wt % following the IP 391 measurement method. Nearly all aromatics were monoaromatics, with less than 0.2% polyaromatics.

In a second variation, a carbon-carbon coupling catalyst with a lower hydrogenation activity, namely a sulphided molybdenum-exchanged zeolite Beta catalyst as prepared in example 5 (carbon-carbon coupling catalyst D), was used in combination with a sulphided hydrotreating catalyst having a lower hydrogenation activity comprising about 14 wt % molybdenum and about 3 wt % cobalt on an alumina support, with the volume ratio of carbon-carbon coupling catalyst to hydrotreating catalyst of 4.7:1. The lower hydrogenation activity of both coupling and hydrotreating catalysts resulted in a hydrocarbon liquid product having a higher aromatic content under comparable operating conditions. The overall WHSV was 0.3 (kg liquid feed/lit cat.hr). Average catalyst bed temperature was 360° C.; and reactor pressure was about 12 MPa. Again a mixed ketone feed as shown in table 1 was contacted with the catalysts. The hydrocarbon liquid product produced was separated from the aqueous layer, and distilled following the ASTM D2892 distillation method. The 140° C. to 250° C. boiling range fraction had a total aromatic content of about 19.5 wt %, out of which polyaromatics were about 5.5 wt %. The density of the liquid was higher than the first variation, at 0.795 g/mL. Thus, it is possible to alter density and aromatic content of hydrocarbon liquid product by altering the strength of hydrogenation function on the catalyst.

### Example 5

### Long Term Operation of a Process for the Conversion C3-C12 Ketones with the Help of a Sulphided Molybdenum-Exchanged Zeolite Beta Catalyst (Carbon-Carbon Coupling Catalyst D

A molybdenum-exchanged zeolite Beta catalyst was prepared as follows: A 0.143 molar (mol/liter) solution of ammonium heptamolybdate tetrahydrate (equivalent to a molybdenum metal concentration of 1 Mol per liter) in water was prepared. The pH of this solution was adjusted to 6.0 using ammonium hydroxide. Zeolite Beta powder having a silica to alumina molar ratio (SiO₂/Al₂O₃ molar ratio) of approximately 20 in ammonium form and having a particle size distribution ranging from about 0.1 micrometer to about 5 micrometer was provided. A slurry of this powder in the ammonium heptamolybdate solution was prepared with a ratio of 10 mL of ammonium heptamolybdate solution per gram of zeolite powder to effect ion exchange. The slurry was heated to 95° C. under refluxing and was maintained at that temperature for a period of 1 hour allowing a molybdenum-exchanged zeolite Beta powder to be produced. After 1 hour, refluxing was stopped and the slurry was allowed to cool to about 50° C. and filtered. The filter cake containing the molybdenum-exchanged zeolite Beta powder was washed with water to remove any free molybdenum from the powder. The molybdenum-exchanged zeolite Beta powder was then dried at room temperature for about 16 hours. Subsequently it was dried at 130° C. for about 16 hours. The molybdenum-exchanged zeolite Beta was then calcined in air at 500° C. for 2 hours. The calcined molybdenum-exchanged zeolite Beta powder was shaped into extrudates using CATAPAL-D boehmite alumina (CATAPAL is a trademark, CATAPAL-D boehmite alumina is commercially obtainable from Sasol) as the binder. The weight ratio of zeolite powder to alumina in the extrudates was 80:20, corresponding to about 80 wt % of molybdenum-exchanged zeolite Beta in the extrudates. The extrudates were re-calcined in air at 500° C. for 2 hours to prepare a molybdenum exchanged zeolite Beta catalyst. The prepared molbydenum-exchanged zeolite Beta catalyst contained approximately 2.5 wt % Molybdenum on the basis of the total weight of the calcined catalyst (carbon-carbon coupling catalyst D).

The molybdenum-exchanged zeolite Beta catalyst (carbon-carbon coupling catalyst D) was used as a carbon-carbon coupling catalyst in a stacked bed configuration with a cobalt-molybdenum hydrotreatment catalyst comprising about 14 wt % molybdenum and about 3 wt % cobalt on an alumina support. The stacked bed consisted of a top bed containing the carbon-carbon coupling catalyst D (i.e. the molybdenum-exchanged zeolite Beta catalyst) and a bottom bed containing the hydrotreatment catalyst (i.e. the catalyst comprising cobalt and molybdenum on an alumina carrier). The volume ratio between the carbon-carbon coupling catalyst D and the hydrotreating catalyst was 82.5:17.5. The top catalyst bed was located upstream of the bottom catalyst bed.

After loading the catalysts into the stacked bed, both catalysts were subjected to a sulfidation treatment. The sulfidation was carried out by using a straight-run gasoil spiked with dimethyl disulfide (DMDS) to obtain an activation feed having 2.5 wt % elemental sulfur. After establishing a hydrogen flow of 250 Nl H₂/(lit cat.hr) and an activation feed flow of 0.50 lit liquid/(lit cat.hr), the reactor temperature was increased to 360° C. and held at that temperature until H₂S levels in the off-gas stabilized. If so desired sulfidation of the catalyst can also be accomplished using gas-phase sulfidation with 5 vol % H₂S/H₂ mixture as the sulfiding medium, but this was not applied for this experiment.

To illustrate the stability of the sulphided molybdenum-exchanged zeolite Beta catalyst in the process of the invention, a long-term test was conducted where, in the presence of hydrogen, a mixed ketone feed having the composition as shown in table 1 was contacted with the carbon-carbon coupling catalyst (i.e. the sulphided molybdenum-exchanged zeolite Beta catalyst) in the top (first) catalyst bed and the hydrotreatment catalyst (i.e. the sulphided catalyst comprising cobalt and molybdenum on an alumina carrier) in the bottom (second) catalyst bed in the reactor. The mixed ketone feed was spiked with dimethyldisulphide (DMDS) such that it contained about 0.1 wt % (1000 ppmw) sulphur.

A step-wise program was applied where the reactor temperature was increased from 250° C. to 360° C. in steps while holding at each step for several days. The temperature was then reduced in steps to 320° C. The detailed conditions for the step-wise program are listed in table 4. During the temperature ramp-up, at 320° C. and a hydrogen partial pressure of 12 MegaPascal (condition C in table 4), a middle distillate product yield (defined as that part of the product boiling between 140° C. and 370° C. based on ASTM D2887) of 14-15 wt % was obtained after about 320 hours on stream. During the ramp-down, at the same temperature (condition G in table 4), after >700 hours on stream, middle distillate yield remained stable at 14-15 wt % even though a lower pressure of 6 MegaPascal was applied. Thus, the sulphided molybdenum-exchanged zeolite Beta catalyst continued to act as a carbon-carbon coupling catalyst after an extended time on stream.

Thus, the use of a catalyst as claimed in the current invention in combination with hydrogen partial pressures of more than 1.0 MegaPascal, more preferably more than 2.0 MegaPascal provides extended stability against deactivation due to coke formation and/or catalyst poisoning.

TABLE 4
Detailed Conditions for the Step-Wise Program in Example 5

| | | Hydrogen | WHSV | Hydrogen to | |
|---|---|---|---|---|---|
| | | partial | (kg | liquid ratio | |
| | Temperature | pressure | liq/lit | (Nl H₂/kg | Product |
| Condition | (° C.) | (MPa) | cat.hr) | feed) | examined |
| A | 250 | 12.0 | 0.28 | 750 | |
| B | 280 | 12.0 | 0.28 | 750 | |
| C | 320 | 12.0 | 0.28 | 750 | x |
| D | 360 | 12.0 | 0.28 | 750 | |
| E | 360 | 8.0 | 0.28 | 750 | |
| F | 360 | 4.0 | 0.28 | 750 | |
| G | 320 | 5.8 | 0.28 | 750 | x |

### Example 6

### Conversion of a Mixed Feed of Ketones in a Stacked Bed Containing a Nickel-Impregnated Mordenite Zeolite Catalyst (Carbon-Carbon Coupling Catalyst E) and a Hydrotreatment Catalyst

Extrudates were prepared by mixing mordenite zeolite (obtained from Zeolyst International), having a SiO2 to Al2O3 molar ratio of approximately 20, with CATAPAL-D boehmite alumina (CATAPAL is a trademark, CATAPAL-D boehmite alumina is commercially obtainable from Sasol) as a binder in a ratio of 20 wt % alumina to 80 wt % mordenite zeolite. The extrudates containing 80 wt % mordenite zeolite bound with 20% CATAPAL-D boehmite alumina were impregnated with a Nickel (II) nitrate solution to obtain a nickel exchanged mordenite zeolite with a nickel loading of 0.9 wt %. The Nickel(II) nitrate was used as the nickel precursor. The impregnated extrudates were calcined at 500° C. to obtain a nickel-impregnated mordenite zeolite catalyst (carbon-carbon coupling catalyst E).

The prepared nickel-impregnated mordenite zeolite catalyst (carbon-carbon coupling catalyst E) was loaded into a stacked bed system as a top bed catalyst. The bottom catalyst bed of the stacked bed system contained a nickel-molybdenum hydrotreating catalyst containing about 18 wt % molybdenum, about 5 wt % nickel and about 3 wt % phosphor on an alumina support (herein also referred to as 5Ni-18Mo/Al). The volume ratio of carbon-carbon coupling catalyst to hydrotreating catalyst was 4:1, and the corresponding weight ratio was 2.7:1.

Subsequently the loaded carbon-carbon coupling catalyst E and the nickel-molybdenum hydrotreating catalyst were subjected to a liquid phase sulfidation treatment using a sulfidation feed. The sulfidation feed was a gasoil spiked with dimethyldisulphide (DMDS) to obtain a sulfur content of 2.5 wt % in the feed. Sulfidation was carried by flowing hydrogen and the sulfidation feed over the stacked bed catalyst system at a temperature of 320° C. and a pressure of 2.5 MegaPascal for a period of 4 hours.

After sulphiding of the catalysts, a feed containing a mixture of ketones having predominantly 3 to 10 carbon atoms as illustrated in table 5 was contacted with the catalysts at the conditions summarized in table 6 for example 6.

The feed containing the mixture of ketones was derived from the fermentation of food waste.

TABLE 5
Mixed Ketone Feed used in Examples 6, 7 and 8

| Component | Wt % |
|---|---|
| Acetone | 12.8 |
| 2-Butanone | 11.3 |
| 2-Pentanone | 17.4 |
| Methyl isobutyl ketone | 1.6 |
| 2-Hexanone | 6.9 |
| 4-Heptanone | 1.1 |
| 3-Heptanone | 0.9 |
| 2-Heptanone | 10.8 |
| 4-Octanone | 1.3 |
| 3-Octanone | 2.0 |
| 2-Octanone | 2.6 |
| 4-Nonanone | 2.2 |
| 3-Nonanone | 0.5 |
| 2-Nonanone | 1.00 |
| 3-Decanone | 0.23 |

The sulfur content of this feed was about 500 ppmw.

The feed was spiked with dimethyldisulphide (DMDS) to increase its sulfur content to about 1100 ppmw. The feed also had a total nitrogen content of about 1700 ppmw, out of which about 410 ppmw was basic nitrogen. The elemental oxygen content of the feed was measured to be about 20%.

The processing of the feed was carried out over the stacked bed catalyst system at an average bed temperature of 341° C. and a reactor pressure of 12 MegaPascal. A hydrogen to liquid feed ratio of 1952 Nl H2/kg feed was used, and the space velocity with reference to the carbon-carbon coupling catalyst was 0.52 kg liquid feed/(kg catalyst.hr). The overall space velocity was 0.38 kg liquid feed/(kg catalyst.hr).

A two-layered product comprising an aqueous layer and an organic (hydrocarbon) layer was obtained.

The liquid hydrocarbon product (in this case consisting of the organic hydrocarbon layer) was separated from the reactor effluent. Product characteristics for the liquid hydrocarbon product obtained are listed in table 7 for example 6. The hydrocarbon liquid was analyzed for its boiling range using SIMDIS (ASTM D2887 method). The liquid hydrocarbon product fraction boiling between 140° C. and 370° C. may be suitable for use in a jet fuel and/or diesel after further distillation. The liquid hydrocarbon product fraction boiling between C5-140° C. may be suitable as a hydrocarbon boiling in the gasoline range.

### Example 7

### Conversion of a Mixed Feed of Ketones in a Stacked Bed Containing a Co-Mulled Nickel-Zeolite Beta Catalyst (Carbon-Carbon Coupling Catalyst F) and a Hydrotreatment Catalyst

A carbon-carbon coupling catalyst was prepared by co-mulling as follows. Zeolite Beta powder in an ammonium form having an SiO2 to Al2O3 molar ratio of 25 was co-mulled with PURAL SB boehmite alumina (PURAL is a trademark, PURAL-SB boehmite alumina is commercially obtainable from Sasol) as a binder. The weight ratio of zeolite beta powder to the alumina binder was 4:1. During mulling, a nickel nitrate solution was added to achieve a nickel loading of 2 wt % on the final extrudate (corresponding to a 2.54 wt % nickeloxide (NiO) loading). The co-mulled material was extruded and the extrudates were calcined at a temperature of 500° C. to prepare the co-mulled nickel-zeolite beta catalyst (carbon-carbon coupling catalyst F).

The prepared co-mulled nickel-zeolite beta catalyst (carbon-carbon coupling catalyst F) was loaded into a stacked bed system as a top bed catalyst. The bottom catalyst bed of the stacked bed system contained a nickel-molybdenum hydrotreating catalyst containing about 18 wt % molybdenum, about 5 wt % nickel and about 3 wt % phosphor on an alumina support. The weight ration of carbon-carbon coupling catalyst F to nickel-molybdenum hydrotreating catalyst was 1.82:1

The catalyst system was subjected to a liquid phase sulfidation treatment using a sulfidation feed. The sulfidation feed was a gasoil spiked with dimethyldisulphide (DMDS) to obtain a sulfur content of 2.5 wt % in the feed. Sulfidation was carried by flowing hydrogen and the sulfidation feed over the stacked bed catalyst system at a temperature of 320° C. and a pressure of 2.5 MegaPascal for a period of 4 hours. Both catalyst systems were subjected to identical sulfidation treatment.

A mixed ketone feed as illustrated in table 5 was processed over the combination of carbon-carbon coupling catalyst F and nickel-molybdenum hydrotreatment catalyst at a temperature of 360° C. The reactor having a stacked bed catalyst configuration with the carbon-carbon coupling catalyst F at the top, and the hydrotreating catalyst at the bottom, was loaded with 510 mg of the carbon-carbon coupling catalyst and 280 mg of the hydrotreating catalyst. The mixed ketone feed flow to this reactor was 304 mg/hr, resulting in a weight hourly space velocity, based on carbon-carbon coupling catalyst, of 0.60 kg feed/(kg catalyst.hr), while that based on the hydrotreating catalyst was 1.08 kg feed/(kg catalyst.hr). Overall weight hourly space velocity for the stacked bed system was 0.39 kg feed/(kg total catalyst.hr).

The liquid hydrocarbon product was separated from the reactor effluent. Product characteristics for the liquid hydrocarbon product obtained are listed in table 7 for example 7.

### Comparative Example 8

### Conversion of a Mixed Feed of Ketones in Catalyst Bed Containing Only a Hydrotreatment Catalyst

1344 milligram (mg) of the hydrotreatment catalyst used in example 7 was subjected to a liquid phase sulfidation treatment using a sulfidation feed. The sulfidation feed was a gasoil spiked with dimethyldisulphide (DMDS) to obtain a sulfur content of 2.5 wt % in the feed. Sulfidation was carried by flowing hydrogen and the sulfidation feed over the catalyst at a temperature of 320° C. and a pressure of 2.5 MegaPascal for a period of 4 hours.

A mixed ketone feed as illustrated in table 5 was processed over the hydrotreatment catalyst at a temperature of 360° C. The mixed ketone feed flow was 330 mg/hr. Thus, in this example the reactor was operated with a weight hourly space velocity of 0.25 kg feed/(kg catalyst.hr).

The liquid hydrocarbon product (in this case consisting of the organic hydrocarbon layer) was separated from the reactor effluent. Product characteristics for the liquid hydrocarbon product obtained are listed in table 7 for comparative example 8.

As illustrated by example 7 and comparative example 8, the presence of a carbon-carbon coupling agent may increase the yield of middle distillate boiling hydrocarbons by about 100%.

Example 6 even shows an improvement in yield of middle distillate boiling hydrocarbons of about 170%, as compared to comparative example 8.

TABLE 6
Process Conditions for Examples 6, 7 and Comparative Example 8 (All on A Single
Pass Basis Without any Gas or Liquid Recycle)

| | Example | | |
|---|---|---|---|
| | 6 | 7 | 8 (comparative) |
| CCC cat. (SAR) | E (20) | F | not applicable |
| Weight of CCC cat. (mg) | — | 510 | not applicable |
| HT cat. | sulfided 5Ni—18Mo/Al | sulfided 5Ni—18Mo/Al | sulfided 5Ni—18Mo/Al |
| Weight of HT cat. (mg) | — | 280 | 1344 |
| Weight ratio CCC cat. | 2.7:1 | 1.82:1 | not applicable |
| to HT cat. | | | |
| WHSV CCC cat. (kg | 0.52 | 0.60 | not applicable |
| liquid feed/kg cat.hr) | | | |
| WHSV HT cat. (kg liquid | 1.40 | 1.07 | 0.25 |
| feed/kg cat.hr) | | | |
| Temperature (° C.) | 340 | 360 | 360 |
| Pressure (MegaPascal) | 12 | 2.5 | 2.5 |
| Hydrogen to mixed | 1952 | 2332 | 2126 |
| ketone feed ratio (Nl | | | |
| H2/kg feed) | | | |

“CCC cat.” refers to the “carbon-carbon coupling catalyst”; and the abbreviation “HT cat.” refers to the “hydrotreatment catalyst”.

TABLE 7
Product Characteristics for the Liquid Hydrocarbon Product in
Examples 6, 7 and Comparative Example 8

| | Example | | |
|---|---|---|---|
| | 6 | 7 | 8 (comparative) |
| Oxygen content of the | <0.2 | 0.23 | 0.1 |
| liquid hydrocarbon | | | |
| product(wt %) | | | |
| Smooth boiling above | 150 | — | — |
| (° C.) | | | |
| 140° C.-370° C. boiling | 21 | 15.51 | 7.75 |
| range fraction* (wt % | | | |
| based on weight of | | | |
| ketone feed) | | | |
| C5-140° C. boiling range | 47 | — | — |
| fraction* (wt % based | | | |
| on weight of ketone | | | |
| feed) | | | |

*boiling fractions are based on ASTM D2887 SIMDIS method.

1. A sulphided carbon-carbon coupling catalyst comprising equal to or more than 60 wt % of a zeolite and in the range from equal to or more than 0.1 wt % to equal to or less than 10 wt % of a hydrogenation metal, based on the total weight of the carbon-carbon coupling catalyst;
wherein the zeolite comprises 10-membered and/or 12-membered ring channels and a Silica to Alumina molar Ratio (SAR) in the range from equal to or more than 10 to equal to or less than 300.

2. The sulphided carbon-carbon coupling catalyst according to claim 1, wherein the carbon-carbon coupling catalyst comprises in the range from equal to or more than 0.5 wt % to equal to or less than 5 wt % of a hydrogenation metal, based on the total weight of the carbon-carbon coupling catalyst.

3. The sulphided carbon-carbon coupling catalyst according to claim 1, wherein the carbon-carbon coupling catalyst comprises one or more hydrogenation metals chosen from the group consisting of copper, molybdenum, tungsten, cobalt and nickel.

4. The sulphided carbon-carbon coupling catalyst according to claim 1, wherein the carbon-carbon coupling catalyst only contains hydrogenation metals chosen from the group consisting of nickel, cobalt, molybdenum, copper, tungsten and combinations thereof.

5. The sulphided carbon-carbon coupling catalyst according to claim 1, wherein the zeolite is a zeolite chosen from the group consisting of MFI-type zeolites, FER-type zeolites, BEA-type zeolites, MOR-type zeolites, FAU type zeolites and combinations thereof.

6. The sulphided carbon-carbon coupling catalyst according to claim 1, wherein the zeolite has a Silica to Alumina molar Ratio (SAR) in the range from equal to or more than 10 to equal to or less than 100 before modification with a hydrogenation metal.

7. The sulphided carbon-carbon coupling catalyst according to claim 1, wherein the carbon-carbon coupling catalyst comprises in the range from equal to or more than 70.0 wt % to equal to or less than 95.0 wt % of the zeolite, based on the total weight of the carbon-carbon coupling catalyst.

8. A method for the preparation of a carbon-carbon coupling catalyst comprising the steps of:
i) adding and/or suspending a zeolite, which zeolite comprises 10-membered and/or 12-membered ring channels and which zeolite has a Silica to Alumina Ratio (SAR) in the range from equal to or more than 10 to equal to or less than 300, into a aqueous metal salt solution, which aqueous metal salt solution comprises in the range from equal to or more than 0.5 to equal to or less than 3.0 mol of a hydrogenation metal per liter of water and which aqueous metal salt solution has a pH in the range from equal to or more than 5 to equal to or less than 10, wherein the zeolite is added and/or suspended in the aqueous metal salt solution in a ratio of grams zeolite to milliliters aqueous metal salt solution in the range from equal to or more than 0.05 to equal to or less than 0.33 grams of zeolite per milliliter of aqueous metal salt solution to produce a zeolite slurry;
ii) heating the zeolite slurry for a time period in the range from equal to or more than 30 minutes to equal to or less than 2 hours at a temperature in the range from equal to or more than 60° C. to equal to or less than 100° C. to produce a ion-exchanged zeolite slurry;
iii) cooling the ion-exchanged zeolite slurry to a temperature equal to or below 55° C. to produce a cooled ion-exchanged zeolite slurry;
iv) recovering the ion-exchanged zeolite from the cooled ion-exchanged zeolite slurry to produce a recovered ion-exchanged zeolite and optionally washing the recovered ion-exchanged zeolite;
v) drying the recovered ion-exchanged zeolite at a temperature in the range from equal to or more than 80° C. to equal to or less than 150° C. for a time period of equal to or more than 1 hour, preferably in air, to produce a dried ion-exchanged zeolite;
vi) calcining the dried ion-exchanged zeolite in air at a temperature in the range of from equal to or more than 400° C. to equal to or less than 600° C. for a time period in the range from 30 minutes to 12 hours to produce a calcined ion-exchanged zeolite;
vii) extruding the calcined ion-exchanged zeolite with a binder and/or a filler in a weight ratio of weight calcined ion-exchanged zeolite to total weight of any binder and/or any filler in the range from equal to or more than 60:40 to equal to or less than 80:20 to produce an extrudate;
viii) re-calcining the extrudate at a temperature in the range from equal to or more than 400° C. to equal to or less than 550° C. for a time period in the range from 30 minutes to 12 hours to produce a carbon-carbon coupling catalyst.

9. The method according to claim 8, further comprising sulphiding the carbon-carbon coupling catalyst to produce a sulphided carbon-carbon coupling catalyst.
